(19) United States
(12) Patent Application Publication
(10) Pub. No.: US 2014/0358553 A1
(43) Pub. Date: Dec. 4, 2014

(54) VOICE COMMAND FOR CONTROL OF AUTOMATION SYSTEMS

(71) Applicants: Richard John Helmke, Bedford, NH (US); Richard Tinker, Clarksville, MD (US)

(72) Inventors: Richard John Helmke, Bedford, NH (US); Richard Tinker, Clarksville, MD (US)

(21) Appl. No.: 13/909,817

(22) Filed: Jun. 4, 2013

(51) Int. Cl. G10L 15/22; G10L 15/30

(52) U.S. Cl. CPC G10L 15/22; G10L 15/30
USPC 704/275

(57) ABSTRACT

A software for controlling automation systems by using voice command. A user may speak a command into a microphone that is operatively connected to a computer. The software loaded on the computer may translate the voice command to computer readable commands. The computer may then schedule a specified day and time to implement the commands. During the specified time and day, the computer may control the automation system based on the specified command.

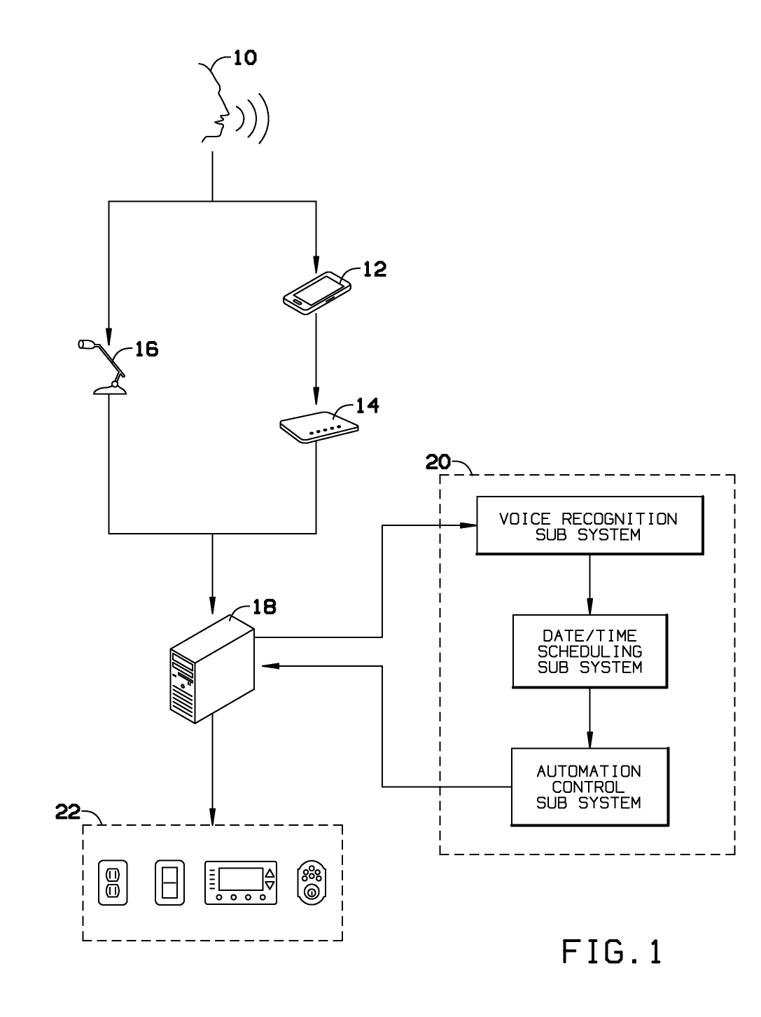

### BACKGROUND OF THE INVENTION

The present invention relates to a voice command software and, more particularly, to a voice command software that controls automation systems.

Automation is the use of machines, control systems and information technologies to optimize productivity in the household, for the production of goods, and delivery of services. The correct incentive for applying automation is to increase productivity, and/or quality beyond that possible with current human labor levels so as to realize economies of scale, and/or realize predictable quality levels. In the scope of industrialization, automation is a step beyond mechanization. Whereas mechanization provides human operators with machinery to assist them with the muscular requirements of work, automation greatly decreases the need for human sensory and mental requirements while increasing load capacity, speed, and repeatability. Automation plays an increasingly important role in the world economy and in daily experience.

When setting up an automation system, such as a system to control lights, heating/cooling systems, and the like, programming the system may be complex. A user normally must answer complicated questions and perform complex tasks. With standard automation systems, users must program their automation systems using complicated forms or unfamiliar technical terms in order to program the system to perform actions that will take place in the future.

As can be seen, there is a need for an easier method of controlling automation systems.

### SUMMARY OF THE INVENTION

In one aspect of the present invention, a system for voice commanding automation systems, comprises: a computer; and a program product comprising machine-readable program code for causing, when executed, the computer to perform the following process steps: receiving a voice command from a microphone that is operatively connected to the computer; translating the voice command to machine readable text and thereby producing a translated command; and controlling the activation of at least one remote appliance operatively connected to the computer using the translated command.

These and other features, aspects and advantages of the present invention will become better understood with reference to the following drawings, description and claims.

### BRIEF DESCRIPTION OF THE DRAWINGS

The FIGURE is a schematic view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a software for controlling automation systems by using voice command. A user may speak a command into a microphone that is operatively connected to a computer. The software loaded on the computer may translate the voice command to computer readable commands. The computer may then schedule a specified day and time to implement the commands. During the specified time and day, the computer may control the automation system based on the specified command.

The present invention relates to a mechanism for creating automatically run events or actions in an automation system using the human voice. By allowing the user to speak a sequence of simple phrases, the present invention may allow a user to easily program the automation system to execute complex tasks on a specified schedule. Simple commands, such as “turn the outside lights off at sunset every day” may be transformed into complex automation events. By allowing the user to quickly create an event using their voice, the user may quickly change how the system operates, whenever it is desired. If the user would like to remind themselves of a special event that takes place next week, the user may say a simple command to create this event.

Referring to the Figure, the present invention may include a system implemented by a program product, such as software. The program product may include a machine-readable program code for causing, when executed, a computer 18 to perform steps. The computer 18 may include any computer including, but not limited to, a desktop, laptop, and smart device, such as, a tablet and smart phone. The program product may include software which may either be loaded onto the computer 18 or accessed by the computer 18. The loaded software may include a program loaded on the hard drive of the computer 18 or an application on a smart device. In alternative embodiments, the software may be accessed by the computer 18 using a web browser. The computer 18 may access the software using the internet, extranet, intranet, host server, internet cloud and the like.

The software 20 of the present invention may include a voice recognition subsystem, a scheduling subsystem, and an automation control subsystem. A voice input device, such as a microphone 16 or smart device 12 with a microphone 14, may be used to input commands to the computer 18. The microphone 16 and/or smart device 12 may be operatively connected to the computer 18 either by a wired connection or a wireless connection. An exemplary user 10 may speak an input command. The input command may include a phrase that may include an appliance 22 operation command, and a date and time to schedule the activation.

In certain embodiments, the phrase may be converted into a computer readable text using the voice recognition subsystem within the software 20. The computer 18 may analyze the translated command and may verify that translated commands are valid based on a preset database of commands. The translated command may then be uploaded to the scheduling subsystem within the software 20. The scheduling subsystem may insert the commands into a scheduling system, such as a calendar. The command may then be queued for execution at the command's specified time and day.

When the correct execution time occurs, the command may be executed by the automation control sub system within the software 20. The automation control sub system may control at least one remote appliance 22 such as a lighting system, a temperature control system, a locking system, an alarm system, or other devices that may be remotely controlled. The computer 18 may thereby execute the commands and the appropriate hardware or software action may be executed.

A method of making the present invention may include the following. The software of the present invention may be constructed to include a voice recognition context comprised of devices, commands, dates, times, and calendar words assembled in such a way as to form voice control possibilities encompassing all of those pieces. The software may be constructed to receive speech, interpret the speech, and convert that speech into text. The software may be constructed to parse and interpret the text to convert it into a command (action or actions) for an object or objects (device or controllable items), at an individual or repeatable time frame for the command to be carried out upon the object or objects. The software may be constructed to carry out the actions on the specific objects. The software may be constructed to store the commands until the commands are needed to be carried out. The software may be constructed to interpret the date and time and process the scheduled commands to happen at the appropriate time or times.

The computer may accept voice from a human operator and may convert the voice to text that the computer may interpret. This text may then be parsed and analyzed so that it may be converted into an event, containing actions that may be executed at a later time. In certain embodiments, the conversion process may take into account multiple different ways that a command may be spoken so as to prevent repetition of the command. The command given may then be held by the computer's memory and may be scheduled to run at a date and time as specified in the voice command. When the date and time arrives, the actions as specified in the voice command may be executed and the proper hardware (such as a light) is then controlled. Actions may also be software actions such as speaking a phrase out of the computer speakers or dialing the phone and speaking a reminder.

In alternative embodiments of the present invention, the storage of the commands may be temporary or permanent. Further, an alternative embodiment may include methods of handling objects to be controlled which have duplicate names, which languages may be used to issue the voice commands, and which types of objects the system is able to control.

By extending the output of the system to include other sub systems, a broad range of hardware may be included. Some other commercial industries may make use of the system, for example a grocery store may use the system to create an event to announce a sale at a specific time each day.

The following is an example of the software being implemented. If a user wanted to turn their outside lights on every night at 6 pm and leave them on for only 6 hours, they could do this easily by speaking to the computer with the command “Every day at 6pm turn on the outside lights for 6 hours.” If the user wanted to be reminded of a doctor's appointment on July 5th at 9 AM, the user may speak the following command to the computer: “Remind me by phone on July 5th at 9 am that I have a doctor's appointment.”

The computer-based data processing system and method described above is for purposes of example only, and may be implemented in any type of computer system or programming or processing environment, or in a computer program, one or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A system for voice commanding automation systems, comprising:
a computer; and
a program product comprising machine-readable program code for causing, when executed, the computer to perform the following process steps:
receiving a voice command from a microphone that is operatively connected to the computer;
translating the voice command to machine readable text and thereby producing a translated command; and
controlling the activation of at least one remote appliance operatively connected to the computer using the translated command.

2. The system of claim 1, wherein the voice command comprises an appliance operation command, a date, and a time.

3. The system of claim 2, further comprising the step of inputting the date and the time in a schedule and implementing the appliance operation command at the date and time scheduled.

4. The system of claim 1, wherein the microphone is a microphone on a smart device operatively connected to the computer.

5. The system of claim 4, wherein the smart device is a smart telephone.

6. The system of claim 1, wherein the at least one appliance is at least one of a lighting system, a temperature control system, a locking system, and an alarm system.
